(19) United States
(12) Patent Application Publication
(10) Pub. No.: US 2008/0235091 A1
(43) Pub. Date: Sep. 25, 2008

(54) Cash in advance incentive and rewards program

(76) Inventor: Christopher Lee Holliday, Orange, CA (US)

Correspondence Address: Ryan Blackstone-Gardner;Solomon, Grindle, Silverman & Spinella, APC, Suite 300, 12651 Highbluff Drive, San Diego, CA, 92130, US

(21) Appl. No.: 11/986,428

(22) Filed: Nov. 21, 2007

Related U.S. Application Data
(60) Provisional application No. 60/919,073, filed on Mar. 20, 2007.

(51) Int. Cl. G06Q 30/00

(52) U.S. Cl. 705/14; 705/26

(57) ABSTRACT

An online cash back rewards system and a product consisting of a rewards card. Under the system presented herein, consumers are provided with a rewards card in advance of earning the rewards through online purchases. The rewards card may contain a fixed dollar value, expiration date, pre-printed web address and unique promotional code/integer identification number. The rewards card, once activated via the web address, is transformed into a digital token which is then passed to participating merchant websites when the consumer clicks through from the incentive site to create an online shopping transaction. The token is then reported back to the host server via electronic transaction reports from each of the online merchants. On the host server, the digital token is used to identify and credit transactions to the consumer's specific rewards account, debiting from the total variable pre-credited value.

### CROSS REFERENCE TO RELATED APPLICATIONS

This application claims priority to and the benefits of U.S. Provisional Application No. 60,919,073, filed Mar. 20, 2007.

### STATEMENT REGARDING FEDERALLY SPONSORED RESEARCH OR DEVELOPMENT

Not Applicable.

### SEQUENTIAL LISTING

Not Applicable.

### BACKGROUND OF THE INVENTION

Manufacturers and retailers are in constant competition to attract consumers with the hope of establishing long term consumer loyalty. To that end, many manufacturers and retailers utilize reward programs to provide incentives to consumers to make repeated online or in-store purchases.

Generally reward programs in the existing marketplace are offered in a variety of forms. Two such forms include: (1) affiliate reward programs offered by online retailers to website owners; and (2) reward programs offered by the manufacturer or retailer directly to the consumer for purchases made online and/or in-store. The way affiliate reward programs work is that the merchant provides links through affiliate consolidators. These consolidators categorize and make the merchant links available to site owners who are registered and approved. The merchants incorporate tracking that allows individual transactions to be reported with additional information, such as unique member identifications that might be assigned by the site owner. When the site owners drive traffic to the merchant sites, any completed transactions are reported back to the consolidator, and payment is made to the site owner for a specific affiliate percentage on those transactions.

The way reward programs offered by the manufacturer or retailer directly to the consumer work is that the manufacturer or retailer will offer a reward (including cash rebates) to the consumer to encourage the consumer to engage in specific purchasing activity. Most typically, the reward program will require a consumer to purchase one or more goods or services to meet a specific rebate/reward threshold set by the manufacturer/retailer. Once that threshold is met, the consumer receives (or applies to redeem) the reward. The reward itself may be in the form of a cash rebate, or may be a product from a catalog of reward items selected by the program provider.

The overview of reward programs in the existing marketplace is that a consumer signs up, they shop and complete a transaction, that transaction is tracked back, and final rebate payment is made or reward is redeemed after a pre-determined threshold is met. While reward programs may operate somewhat differently, reward programs in the existing marketplace tend to exhibit the same problems. First, existing rebate and incentive sites using cash back or product rewards from online or in-store shopping only provide a benefit to the organization if the consumer initiates a transaction. No hard-good benefit is given to the consumer prior to purchase to evidence to the consumer that they received an extra benefit from the transaction so as to encourage consumer loyalty in the form of repeat business. It is only after purchase, and after a consumer goes through a time consuming qualifying process, that the consumer may receive the reward (assuming that the consumer fulfills all of the program requirements). The lack of a hard-good benefit to the consumer, therefore, may have the effect of consumers being less likely to initiate and complete shopping transactions now and in the future. This is particularly problematic because, as an incentive offered by the organization, the direct benefit to the organization is based completely on the percentage of individuals who actually visit the site (or store) and initiate and complete an online or in-store shopping transaction.

A second problem of the existing reward programs is that there is no fixed value set on the benefits the consumer receives—it is only based on the consumer's usage and the rebate value of the merchant transaction. If it is a shopping rewards site, the member site earns a percentage of the merchant's cash back reward based solely on the actual purchases made by the consumers. If it is a fundraising site, the fundraising organization receives a percentage of the cash back reward based solely on the actual purchases made by the consumers. These business models are based on retention of a percentage of the reward by the company operating the site and providing the service. However, because the percentage is based solely on the purchasing activity of the consumer, which is not in the organization's control, it makes it difficult (if not impossible) for the organization offering the reward program to effectively manage and evaluate the success of the reward program.

In addition to the issues discussed above, an additional problem specific to reward programs involving accumulation and redemption of reward points is that various factors tend to delay and/or limit the consumer's satisfaction in receiving the reward. These factors include the length of time required to achieve the threshold and receive the reward product, restrictions concerning the redemption of points for rewards, the inconvenience of the process for redeeming the rewards, the possible loss of reward points through expiration or through the financial failure of the program provider, and the limited selection of products available as rewards. As a result of these and other factors, the consumer is less motivated to continue to participate in the rewards program.

All of the problems discussed above tend to frustrate (and turn away) the very consumers with whom the reward program providers are attempting to build a long term relationship and therefore limit the overall effectiveness of the reward program. A need clearly exists, in view of these observations, for an improved manner of administering reward programs.

The business method provided herein provides a convenient solution to the foregoing problems and offers several additional advantages. The present invention solves the above-stated problems in the art by providing a physical product, in the form of a rewards card or a digital representation thereof, to the customer before the customer has to make a purchase. The rewards card represents a fixed rewards value so that the consumer and the organization both know in advance the value of the reward to be awarded and what consumer activity must occur for the reward to be redeemed. The rewards card (or digital representation thereof) representing the fixed value becomes the incentive ‘product.’ Instead of relying on member's initiating a transaction, incentive and fundraising groups may benefit from the direct transaction of the sale of rewards card product to the consumer that represents the full but as yet unearned online shopping rewards value. The business method employs the rewards card product to add certainty that existing incentive reward programs lack that will allow incentive groups to better manage, evaluate and improve their reward programs.

In short, the rewards card and advance dollar value system offers a product and method for marketing companies, fundraising entities, and any other users as a way to provide a unique value-added incentive not currently available in the market place to attract consumers.

### BRIEF DESCRIPTION OF THE PRIOR ART

U.S. Pat. No. 6,185,541 discloses a system and method for distributing purchasing incentives to retail customers through the means of a central computer over a computer network.

U.S. Pat. No. 5,774,870 discloses an integrated system and method for an incentive reward program wherein a user may receive an item from an award catalog by redeeming award points accumulated through on-line purchases from a product catalog

### SUMMARY OF THE INVENTION

The problems noted above, and others, are overcome by the present invention. The invention herein presented comprises a cash back rewards system and product where consumers are provided with a rewards card or a digital representation of a rewards card featuring a pre-printed web address and unique integer identification number. The rewards card is a physical product or digital representation of a physical product. The rewards card is issued to a consumer in advance of the consumer earning the rewards through online purchases. The rewards card that becomes (when activated) an electronic token for a fixed dollar value that tracks each consumer transaction and allocates it to the consumer's unique integer identification number account in a relational database. The invention preferably relies on a communication infrastructure, for example the Internet, wherein individual interaction is possible, and through which some or all of the following events may take place: (1) the rewards card product is delivered to the consumer; (2) the consumer's transactions are transmitted to a relational database wherein the consumer's account is stored; (3) the consumer's account is credited with each purchase (whether such purchase is made on-line, by catalog, or in-store); (4) a check is issued to a consumer once a threshold is met; and (5) a report of all transactions is sent to each incentive organization detailing all activity on rewards cards issued by each such organization. Other embodiments of delivering and activating the rewards card (such as through mail, in person, or by telephone), tracking the consumer's purchases and allocating such purchases to the consumer's account would be obvious to one skilled in the art.

One embodiment of the invention consists of a rewards card in the form of a plastic PVC card similar in size and shape as a credit card, delivered to the consumer by mail or in person. The size and shape of the plastic rewards card provides the advantage of enabling consumers to easily carry such rewards card in their purses or wallets. Alternatively, the rewards card may also be issued as a digital representation of a physical product (sent to the consumer by email, or downloaded by the consumer from the internet, or otherwise). The digital rewards card provides the advantage of allowing the consumer to store the rewards card on the consumer's card drive or within the consumer's email inbox, thereby allowing the consumer to access the rewards card from their computer or with any remote device that provides access to the consumer's email and/or hard drive. Whether the rewards card is in a physical form or digital representation thereof, the fact that a hard good is provided to the consumer is advantageous because it provides immediate evidence of an extra benefit and makes the consumer more likely to initiate and complete shopping transactions knowing that he or she will receive a benefit from such transactions.

A series of integer identification numbers are assigned to each rewards card in a relational database and appear on the face of the card or within the digital representation of the card. Each rewards card also has a fixed dollar value and expiration date assigned in the database, and a relational pointer to the relational database record respectively corresponding to the organization issuing the card and the consumer holding the card. The integer identification numbers assigned in the relational database are unique to each individual reward card and the integer identification number and relational database together provide the additional advantage of allowing for purchases made using the card to be tracked back and credited to the consumer's account through a digital token.

The rewards cards are provided to each organization based on a fee structure related to the total rewards value of the rewards card and the duration of any expiration date assigned to the rewards card. This allows the organization the advantage of selecting a reward card value and expiration date to best suit its purchasing incentive or fundraising needs. The organization issues the reward cards to consumers as a purchasing incentive or fundraising product.

One embodiment of the invention employs an online mechanism to notify the consumer of their rewards benefit and to activate the rewards card. One such mechanism involves a web address listed on the front face of the card. Alternatively, one skilled in the art will recognize other forms of notifying the consumer of their rewards benefit and activating the rewards card, such as email, interactive television, mail, telephone, or other similar methods. The web site corresponding to the web address may be accessible to the public, or, alternatively, an organization may request private label rewards cards and a private label rewards portal. This provides the advantage of flexibility for the organization in fashioning the rewards program to best suit its goals and needs. Regardless of whether the web portal site is private or public, the advantage of the online mechanism is that all web address portals tie in to the same relational database. The rewards card is prepared for activation online when the member accesses the site's web address on the card and enters the access code. The member is then prompted to enter information requested by the organization, for example, the consumer's email address and password. Upon submitting the information, the consumer's card is active and the value is confirmed for the card.

The invention also employs a digital token to track the consumer's transactions. Once the rewards card is activated, the database record/integer identification number now becomes the digital token that is passed online via the web browser. The digital token provides the advantage of allowing each transaction to be tracked automatically and facilitates the automatic update of each consumer's account by corresponding the amount of each transaction to the specific fixed dollar value of the card in the relational database. If the consumer is shopping on-line, the consumer may navigate through his or her web browser to any of the hundreds of participating merchants on the site. This online shopping provides an advantage to the consumer of being able to shop for a wide variety of products and services without having to travel to each individual store, while at the same time the consumer is credited towards a cash rebate reward with each purchase. The digital token containing the consumer's card number is automatically stored in a session variable and/or an electronic ‘cookie’ on the server for the period the consumer is logged in. When the consumer clicks on a link to a specific merchant to initiate a shopping transaction, the digital token is passed to the merchant site and captured by the merchant's server for tracking the transaction. Alternatively, if the consumer is shopping in-store, when the consumer makes a purchase at a qualified site using their rewards card, then the digital token information is stored in the merchant's server and is directed to the relational database through software provided to the merchant.

One embodiment of the invention is a transaction report generated in the relational database. When the consumer completes the shopping transaction, the merchant generates a report of the transaction that includes the consumer's integer identification number, the date, time, total of the purchase, and the total amount to be applied to the cash rebate reward. That report is periodically imported into the relational database via a process programmed on the web server that reads the text file generated by the merchants reporting software, and writes the unique data into specific fields in the relational database. Upon import, the digital token/integer identification number is verified against the relational database. A new record is created that includes the transaction details and this new report is provided to the organization. This is particularly advantageous because the organization does not need to expend time and effort to track each individual transaction to each reward card; instead, this task is performed automatically.

One embodiment of the invention involves the automatic distribution of cash rewards once the preset limit is met. Once the digital token is verified against the database, a credit is applied to the consumer's integer identification number account corresponding to the total dollar rebate value of the transaction. The dollar value is deducted from the remaining value on the consumer's integer identification number account and the reported information becomes available online to the consumer as soon as it is imported to the relational database. Checks are distributed to each consumer for their transactions on a monthly basis when their credited cash transactions exceed a preset limit set by each organization using the reward card system. This relational database update and check distribution system provides several advantages over existing rewards, namely, that the transaction update and check distribution system are performed automatically, thereby significantly reducing the amount of time the consumer must wait between purchase and redeeming the reward, that the consumer has instant access to his or her reward status and that the consumer does not need to spend the time and energy to fill out forms, send in documentation, and follow up to ensure the reward earned is actually delivered to the consumer all of which help to engender loyalty from the consumer.

### BRIEF DESCRIPTION OF THE DRAWINGS

FIG. 1 is a front perspective view of one embodiment of the invention showing the front face of the rewards card as a physical product;

FIG. 2 is a rear perspective view of one embodiment of the invention showing the rear face of the rewards card as a physical product.

FIG. 3 is a step by step list of how the rewards card is utilized within the method portion of the invention demonstrating the process by which the rewards card is provided to an organization based on a fee structure to be used as a incentive or fundraising product, the organization distributes a reward card to a consumer, the consumer activates the card, uses the reward card on various member sites, the transactions are recorded and applied to the consumer's integer identification number account, and the consumer receives a cash distribution once the transactions exceed a preset limit set by the organization.

### DETAILED DESCRIPTION OF SOME EMBODIMENTS OF THE INVENTION

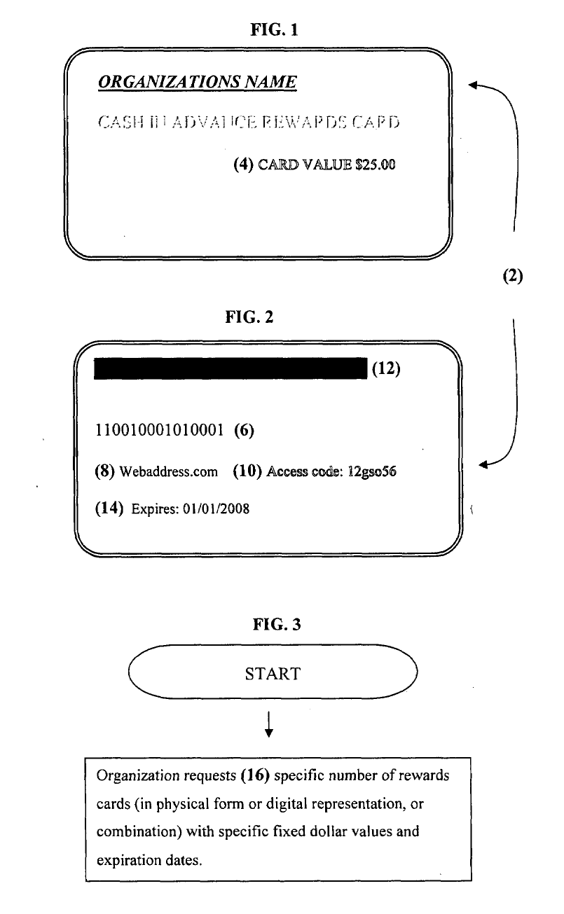

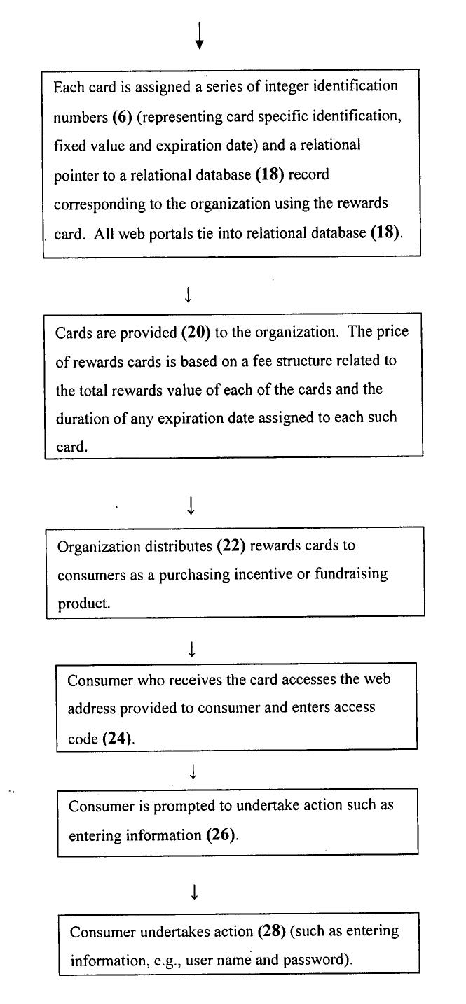

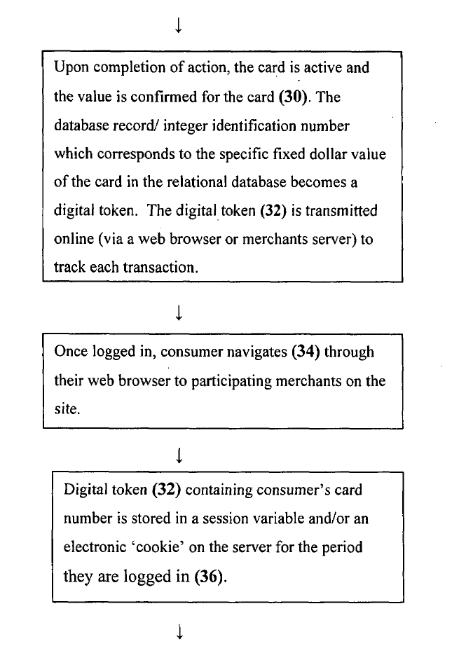

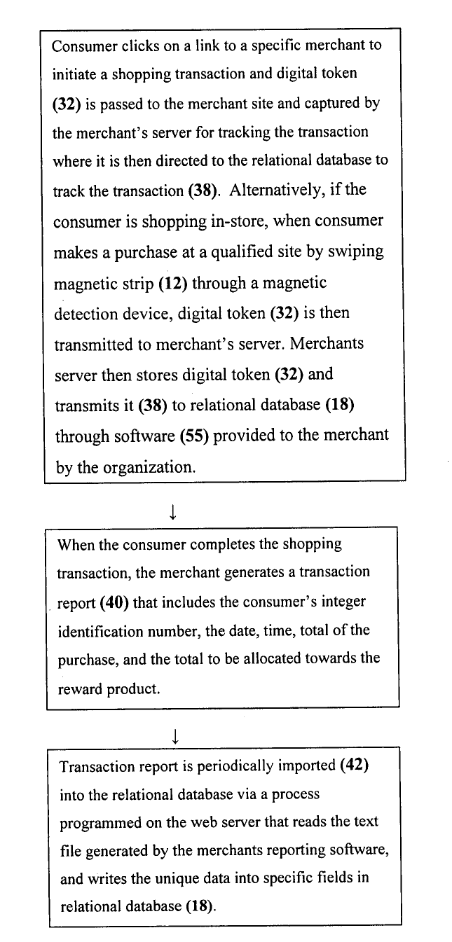

Referring to the figures, Rewards card (2) is shown in FIG. 1 in the preferred embodiment of a plastic PVC card similar in size and shape as a credit card, however, as one reasonably skilled in the art will appreciate, Rewards card (2) may be in a different size and shape and may also be in the form of a digital representation of a physical product without violating either the scope or spirit of the invention. Rewards card (2) contains a series of integer identification numbers (6) which identifies Rewards card (2) in relational database (18). Preferably, integer identification number (6) appears on the rear face of Rewards card (2), as shown in FIG. 2, however, integer identification number (6) may be placed in a variety of locations on the card.

Rewards card (2) also has a fixed dollar value (4) and an expiration date (14) assigned in relational database (18), and a relational pointer to relational database (18) which respectively corresponds and tracks the organization issuing Rewards card (2) and the purchase transactions of the consumer holding Rewards card (2). Fixed dollar value (4) is preferably imprinted on the front face of Rewards card (2) as shown in FIG. 1, however, fixed dollar value (4) may be placed in a variety of locations on Rewards card (2) without violating either the scope or spirit of the invention. Expiration date (14) is preferably imprinted on the rear face of Rewards card (2) as shown in FIG. 2, however, expiration date (14) may likewise be placed in a variety of locations on Rewards card (2) without violating either the scope or spirit of the invention.

As shown in FIG. 2, web address (8) and access code (10), are imprinted on the rear face of Rewards card (2). Alternatively, the web address (8) and access code (10) may be imprinted in different locations on Rewards card (2) depending on the organization's preference. One reasonably skilled in the art will appreciate that Rewards card (2) may be configured in a variety of different shapes, sizes, configurations and orientations, and that fixed dollar value (4), expiration date (14), web address (8) and access code (10) may be imprinted in a variety of locations on Rewards card (2) without departing from the scope and spirit of the invention.

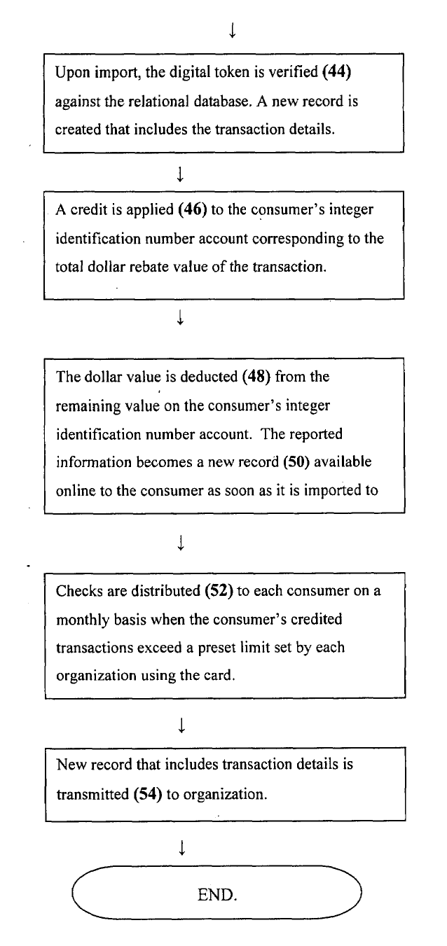

As shown in FIG. 3, organization requests (16) a specific number of Rewards card (2) with specified fixed dollar values (4) and expiration dates (14). Rewards card (2) is provided (20) to each organization based on a fee structure related to fixed dollar value (4) and the duration of expiration date (14) assigned to the each such rewards card. Organization then distributes (22) Rewards card (2) to consumers as a purchasing incentive or fundraising product.

Web address (8) is part of a mechanism to notify the consumer of the reward and activate Rewards card (2). Preferably, the mechanism to notify the owner of Rewards card (2) is an online mechanism, but one skilled in the art will appreciate that Rewards card (2) may be distributed in a variety of ways, including the internet, interactive television and mail without violating the scope and spirit of the invention. The web site corresponding to web address (8) may be accessible to the public, or, alternatively, an organization may request private label cards and a private label rewards portal. All web address portals tie into relational database (18).

Preferably, Rewards card (2) is prepared for activation online (24) when the member accesses web address (8) and enters access code (10). Consumer is then prompted (26) to take specified actions requested by the organization to activate the card. Such activation mechanism may be accomplished by prompting the consumer to enter his or her email address and password while on the internet. However, one reasonably skilled in the art will appreciate there are numerous ways in which Rewards card (2) may be activated without violating the scope and spirit of the invention, including activation by the internet, interactive television and telephone. Upon taking the requested action (28), Rewards card (2) is activated and the fixed dollar value (4) and expiration date (14) is confirmed (30) for Rewards card (2) in relational database (18).

Once Rewards card (2) is activated, the database record /integer identification number (6) now becomes a digital token (32) that is passed online via the web browser. The digital token provides the advantage of allowing each transaction to be tracked automatically and facilitates the automatic update of each consumer's account by corresponding the consumer's transactions to integer identification number (6) to the specific fixed dollar value (4) of Rewards card (2) in relational database (18). If the consumer is shopping on-line, the consumer may navigate through their web browser to any of the hundreds of participating merchants on the site (34). Digital token (32) containing the consumer's card number is automatically stored in a session variable and/or an electronic ‘cookie’ on the server for the period the consumer is logged in (36). When the consumer clicks on a link to a specific merchant to initiate a shopping transaction, digital token (32) is passed to the merchant site, captured by the merchant's server for tracking the transaction and transmitted (38) to relational database (18). Alternatively, if the consumer is shopping in-store, when consumer makes a purchase at a qualified site by swiping magnetic strip (12) (preferably located on the rear face of Rewards card (2)) through a magnetic detection device, digital token (32) is then transmitted to merchants server. Merchants server then stores digital token (32) and transmits it (38) to relational database (18) through software (55) provided to the merchant by the organization. One reasonably skilled in the art will appreciate that there are a variety of ways to track consumer transactions to relational database (18) without violating the scope and spirit of the invention.

When the consumer completes the shopping transaction, the merchant generates transaction report (40). Transaction report (40) preferably includes the consumer's token identification number, the date, time, total of the purchase, and the total amount to be applied to the cash rebate reward, however, one reasonably skilled in the art will appreciate that transaction report (40) may contain a variety of information and be organized in a variety of forms without violating the scope and spirit of the invention. Transaction report (40) is periodically imported (42) into relational database (18) via a process programmed on the web server that reads the text file generated by the merchants reporting software and writes the unique data into specific fields in the relational database. Upon import, identification of digital token (32) is verified (44) against relational database (18).

After digital token (32) is verified against the database, a credit (46) is applied to the consumer's integer identification number in the relational database corresponding to the total dollar rebate value of the transaction. The dollar value is deducted (46) from the remaining value on the member's integer identification number (6). The reported information becomes new record (50) and is available online to the consumer as soon as it is imported to relational database (18). Checks (or other forms of rewards) are then periodically distributed (52) to each consumer on a monthly basis when consumer's credited cash transactions exceed a preset limit set by each organization using the reward card system. New record (50) that includes transaction details is then transmitted (54) to the organization.

We claim:

1. A cash in advance rewards program system, preferably operable over a computer network, for the purpose of allowing an organization to generate revenue by selling or distributing a rewards card product with a fixed value and expiration date to a consumer and allowing said consumer to receive a fixed cash back reward once a purchase transaction threshold is met, wherein when a consumer performs a purchase transaction in a participating merchant store using said rewards card product, reward card points are assigned to said purchase transaction in said participating merchant store based on payment amount of said purchase transaction, and said participating merchant store sends transaction information consisting of the amount corresponding to the purchase transaction to a database, wherein the purchase transaction amount is added to a consumer's account in said database, and wherein said consumer receives a pre-determined cash back reward when said consumer has satisfied a purchase transaction threshold using said rewards card product, the system comprising:
a rewards card product provided to a participating organization for sale or distribution to a consumer, said rewards card product being suitably adapted to store and transmit information;
a communication system preferably operable over the internet and accessible by at least one of a program provider, a participating organization, a consumer and a participating merchant to allow said consumer to activate a rewards card account, view said rewards card account, make purchases using said rewards card product from at least one of said participating merchants, and receive a cash reward when said consumer has satisfied said purchase transaction threshold;
a database system accessible by said communication system and said program provider, for retaining data relevant to said cash in advance rewards program system;
means for passing records of purchase transactions and adding the amounts of said purchase transactions to said consumer's account in said database;
a fraud detection system accessible by said program provider to determine whether said consumer interacting with said communication system is the correct user;
an account verification system accessible by said program provider to verify said purchase transactions are allocated to the proper consumer account;
a system for providing said cash back reward to said consumer when said consumer has satisfied said purchase transaction threshold.

2. The rewards card product of claim 1, further comprising:
information in electronic or magnetic form assigned to said rewards card product including
a fixed dollar value
an expiration date
an integer identification number, and
an access code;
means for activating said rewards card product to create a consumer account in said database and track said purchase transactions; and
means for storing electronic or magnetic information in said rewards card product.

3. The rewards card product of claim 2 wherein said means for activating said rewards card product to create said consumer account and track purchase transactions comprises the recipient of a rewards card product logging onto said program provider's website, entering information comprising at least said integer identification number said access code and certain additional personal information selected by participating organization.

4. The rewards card product of claim 2 wherein said rewards card product is provided to said consumer in the form of a digital representation of physical product, transmitted over the internet to consumer's email or downloaded by consumer to consumer's personal computer.

5. The rewards card product of claim 2 wherein said rewards card product is provided to the consumer in the form of a physical product similar in size, shape and composition to a plastic credit card.

6. The rewards card product of claim 2, wherein said means for storing electronic or magnetic information comprises a magnetic stripe suitably adapted to storing electronic or magnetic information.

7. The database storage system according to claim 1 further comprising means for storing data relating to each activated rewards card product and purchase transactions using said rewards card product in at least one of a consumer account and a participating organization account.

8. The consumer account according to claim 7 further comprising a unique integer identification number identification number, fixed monetary limit, expiration date and access code assigned to said consumer account in said database for purpose of tracking and allocating purchase transactions made with said rewards card product.

9. The database according to claim 7 wherein credits corresponding to the total dollar value of said consumer's purchase transactions are applied to said consumer's pre-set fixed limit in said consumer's account.

10. The communication system of claim 1 further comprising means to allow customer to activate said consumer account and view said consumer's account status.

11. The communication system of claim 10 wherein said communication system comprises a website accessible by at least one of a program provider, a participating organization, a consumer and a participating merchant, to allow customer to activate said consumer account and view said consumer's account status.

12. The website of claim 11 further comprising means to allow said consumer to activate said consumer account and view said consumer's account status.

13. The website of claim 11 further comprising means for transmitting secured information among at least one of said database, said program provider, said participating organization, said consumer and said participating merchant.

14. The website of claim 11 further comprising internet links to participating merchant websites to allow consumers to shop and complete purchase transactions using said rewards card product at said participating merchant stores while logged onto said website.

15. The rewards card product of claim 2 wherein said integer identification number of said rewards card product becomes a digital token once the consumer activates said rewards card product, said digital token being suitably adapted to pass records of consumer purchase transactions occurring in participating merchant stores from said participating merchants to said database.

16. The digital token of claim 15 wherein said digital token is automatically stored in a session variable/electronic cookie on a consumer's computer while a consumer is logged onto the website of claim 11.

17. The digital token of claim 15 wherein said digital token is passed by a computer network to said participating merchant's websites visited by said consumer and captured by merchant's server when a consumer completes a purchase transaction on said participating merchant's website.

18. The digital token of claim 15 wherein said digital token is suitably adapted to pass records of purchase transactions using the rewards card product from said merchant's server to said database through said communication system.

19. The system of claim 1 wherein said participating merchant store in which said purchase transactions are conducted includes at least one of a real store which the customer visits for face-to-face commercial or service transactions and a virtual store which runs on a computer network.

20. The purchase transaction of claim 20 wherein said purchase transaction is settled using one of electronic currency, cash, a check, a credit card and a debit card.

21. The system of claim 1 wherein the amount of the cash back reward and said purchase transaction threshold is determined by a formula which includes the cost of said rewards card product and said expiration date for said rewards card product.

22. The system of claim 1 further comprising means for determining when a consumer has met a purchase transaction threshold and notifying said participating organization that said consumer has met said purchase transaction threshold.

23. The system according to claim 1 further comprising a financial account management system to allow said rewards card program provider to manage payments between the consumer, program provider, participating merchants and participating organizations.
